(19) United States
(12) Patent Application Publication
(10) Pub. No.: US 2014/0013293 A1
(43) Pub. Date: Jan. 9, 2014

(54) HIERARCHICAL POWER MAP FOR LOW POWER DESIGN

(71) Applicant: Synopsys Taiwan Co., Ltd., Taipei (TW)

(72) Inventors: Chih-Neng Hsu, Taipei (TW); I-Liang Lin, Taipei (TW); Wen-Chi Feng, Taipei (TW)

(73) Assignee: SYNOPSYS TAIWAN CO., LTD., Taipei (TW)

(21) Appl. No.: 13/718,979

(22) Filed: Dec. 18, 2012

Related U.S. Application Data
(63) Continuation-in-part of application No. 13/158,471, filed on Jun. 13, 2011, now Pat. No. 8,365,132.
(60) Provisional application No. 61/358,002, filed on Jun. 24, 2010.

(51) Int. Cl. G06F 17/50

(52) U.S. Cl. CPC G06F 17/5022
USPC 716/133

(57) ABSTRACT

Power information associated with an IC design is displayed graphically and hierarchically using a power map, thereby providing an intuitive way for describing the power distribution among various power domains of the IC and parent-child relationships within the power domains. Each power domain is associated with a power control for controlling the power domain. The status of the power control for each power domain is displayed on the power map. The power map may include a token to set and display current operating mode of the IC design to enable the IC design to be debugged under different operating modes.

### CROSS-REFERENCE TO RELATED APPLICATIONS

This application is a continuation-in-part of U.S. application Ser. No. 13/158,471, filed Jun. 13, 2011, and entitled “Hierarchical power map for low power design,” which claims the benefit of priority of U.S. Provisional Application No. 61/358,002, filed Jun. 24, 2010, and entitled “Method and system for displaying IC design intent with power domain intent,” the contents of which are incorporated herein by reference in their entirety.

### BACKGROUND OF THE INVENTION

The present invention relates to a computer-implemented method for debugging low power integrated circuit (IC) design, and in particular, to a method for creating an integrated graphic user interface to debug the IC design and provide a map of its power usage.

Mobile and consumer electronic devices such as personal mobile computers, MP3 audio players, notebooks and digital cameras are in wide use. The drive twoards low power consumption in increasingly thinner and lighter products require integration of a number of components on an IC. For example, as more circuits are integrated on a system-on-chip (SoC) IC to perform increasingly more complex functions at lower power, the IC becomes more difficult to debug. In many low power designs, a circuit is divided into many parts, referred to as power domains, each of which may be associated with a power supply. A power domain is a collection of instances, pins and ports that can share the same power distribution network (voltage). Some of the power domains can be turned on or off by a power switch. Power switches are used to turn off unused parts of the design to conserve power consumption.

An isolation cell is used to isolate signals between two power domains where one is switched on and one is switched off Such cells are used to isolate signals originating in a power domain that is being switched off An isolation cell ensures that when a power domain is turned off, its output has a predefined or latched value, thus leaving other active domains unaffected.

A level shifter is typically required to change one voltage level to another voltage level across different power domains. Therefore, a low power SoC IC, in addtion to a number of digital circuits, often includes power network circuitry with a multitude of power components.

Referring to FIG. 1, a digital circuit design is conventionally implemented in hardware description language (HDL), such as Verilog code 1. The term “power specification” is defined herein as the description of the power intent (intended power behavior) of a circuit design. In order to implement low power network, the power description 2 specified in a power format such as Cadence Common Power Format (CPF) or Unified Power Format (UPF) is generally used to capture the power information so as to allow designers to implement low power network design in a separate file without modifying the Verilog code 1. The power format describes low power intent for design implementation, analysis and verification.

In order to specify low power design constraints so as to minimize energy consumption, a power supply network is specified to control the distribution of power. Using UPF, one can specify the network at an abstract level. Such a network includes supply ports, supply nets, power switches, and is a high-level abstraction of the electrical network of the power aspect of the chip. Supply ports provide supply interfaces to power domains and switches, whereas supply nets connect supply ports. Since the supply network is specified apart from the logic design, the logic design specification remains independent of power supply network specifications.

Since traditional hardware description languages (HDL) are not adequate to specify the power design information, a power format, such as UPF, provides a format without changing the existing HDL codes. For instance, UPF provides a command, create_power_domain, for creating a power domain and grouping the design instances associated with the power domain. Other power components, such as power switches, isolation cells, and level shifters may be created by using the corresponding commands defined by the power formats.

Once the Verilog design and the power design based on the power format are taken into consideration, the IC design can be analyzed and debugged. However, to the extent that a conventional circuit design file is separate from the power network design, to debug a circuit a designer is required to establish a relationship between these two files.

Furthermore, circuit designers are primarily focused on the functionalities of the circuit design and to creat hierarchies based on the functional and logic view of the design. However, power designers prefer to have the design hierarchies in a physical form which can be defined by a power format having a multitude of power domains within the power network design. As a result, it is inefficient and error prone for the designers to debug the entire chip if the low power network design is not viewed in the top level and does not interact with the power designer. A need continues to exist for a more efficient and reliable technique to design low power circuits.

### BRIEF SUMMARY OF THE INVENTION

In accordance with embodiments of the present invention, power information is displayed in a graphic window, referred to as a power map, to help users quickly understand the power structure and the relationship between power network design and circuit design to enable easy debugging. The power map includes power domains, isolation cells, level shifters, power switches and power supplies.

One embodiment of the present invention provides a computer-implemented method for generating and displaying a power map, which is a power schematic diagram in a graphic window to show the low power network design based on the low power information defined in a power format in top level, to allow designers debug the low power network design and its associated circuit design, in which the power map comprises a plurality of power domain symbols to represent power domains and to link to the associated parts of the circuit design.

One embodiment in the present invention is to provide a method to generate and display a power map by the following steps. First, the original circuit design HDL codes, which are some text files, are transformed into internal structure which generally is hierarchical structure called circuit design hierarchies and stored in a knowledge data base generated by a HDL parser, and the original circuit design hierarchies of the knowledge data base are regrouped to new hierarchies which are defined by power specification. In the new hierarchies, instances sharing the same power domain are grouped together. After that, the new hierarchies called power domain circuit design hierarchies are stored in a power data base. Finally, the power map is created from the power data base; it can also display the mismatches or errors between the power specification and the circuit design for those improperly handled signals that connect the power domains.

The present invention discloses that the power map comprises low power symbols such as power domain symbols, isolation cells, level shifter cells, and power switch cells. Furthermore, the power map is used in conjunction with a simulation result to provide debugging information to the designers, such as displaying the current values of simulation result for signals in the power map at a specific simulation time or displaying the waveforms of simulation result for a period of simulation time in a waveform window by dragging and dropping selected signals in the power map into the waveform window. Moreover, the power map also provides a methodology to detect which HDL signals are not covered by isolation connection and level shifter connection, and will invoke this function automatically when power map is created.

A feature of the power map, which is displayed in a graphic window, is that it provides some active annotation to easily communicate and interact with users. Accordingly, it is more user friendly to let users debug power network together with digital circuit design in an interactive interface.

Another object of this invention is to provide a solution to display low power information in a graphic window with a hierarchical representation for power domains to provide an intuitive way to view the parent-child relationships among power domains.

One embodiment in the present invention is to provide a method to generate and display the power map with a hierarchical representation, wherein the power map comprises a plurality of power domains and each of the plurality of power domains is associated with the part of the circuit design that belongs to the power domain, wherein the plurality of power domains are grouped into a plurality of sets of power domains with a representation to indicate the boundaries and parent-child relationships among the plurality of power domains. In order to present a hierarchical power map, it is necessary that at least one set of power domains contains at least two power domains in which there is a parent power domain and at least one child power domain inside the parent power domain, wherein each of the power domains is associated with a corresponding power control for controlling the power domain, and the status of the power control is displayed on the power map.

One embodiment of the power map is generated for debugging an IC design having different operating modes, wherein the power map comprises a token to set and display current mode of the IC design. Once the current mode is changed to a new mode, the power domains of the power map will be redrawn under the new mode of the IC design as specified in the low power specification.

The detailed technology and above preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 illustrates a conventional low power digital circuit design methodology;

FIG. 2 is a flowchart of steps performed to create a power map, in accordance with one embodiment of the present invention;

FIG. 3 illustrates a hierarchical circuit design defined by the power specification after regrouping the original circuit design hierarchy, in accordance with one embodiment of the present invention;

FIG. 4A is a schematic diagram showing a power map, in accordance with one embodiment of the present invention;

FIG. 4B is a schematic diagram showing an isolation rule, in accordance with one embodiment of the present invention;

FIG. 4C is a schematic diagram showing a level shifter rule, in accordance with one embodiment of the present invention;

FIG. 4D is a schematic diagram showing a power switch rule, in accordance with one embodiment of the present invention;

FIG. 5 is a signal value list window, in accordance with one embodiment of the present invention;

FIG. 6 is a waveform window, in accordance with one embodiment of the present invention;

FIG. 7 illustrates a hierarchical representation of a power map by grouping the power domains of a circuit design according to the power control and parent-child relationships among the power domains, in accordance with one embodiment of the present invention;

FIG. 8 is a flowchart of steps performed in creating a hierarchical representation of a power map, in accordance with one embodiment of the present invention.

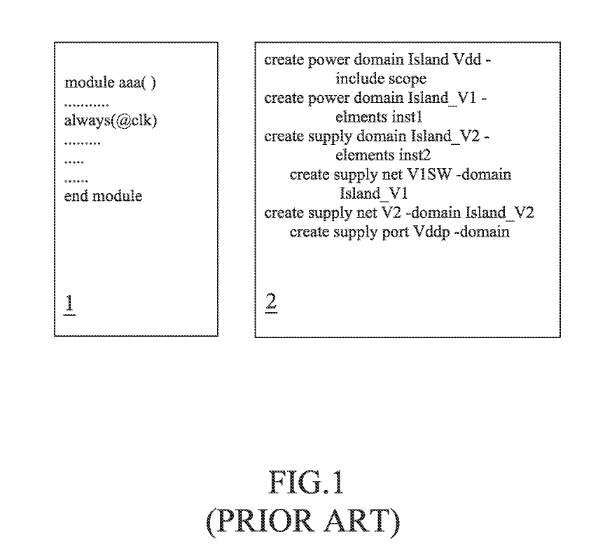

### DETAILED DESCRIPTION OF THE INVENTION

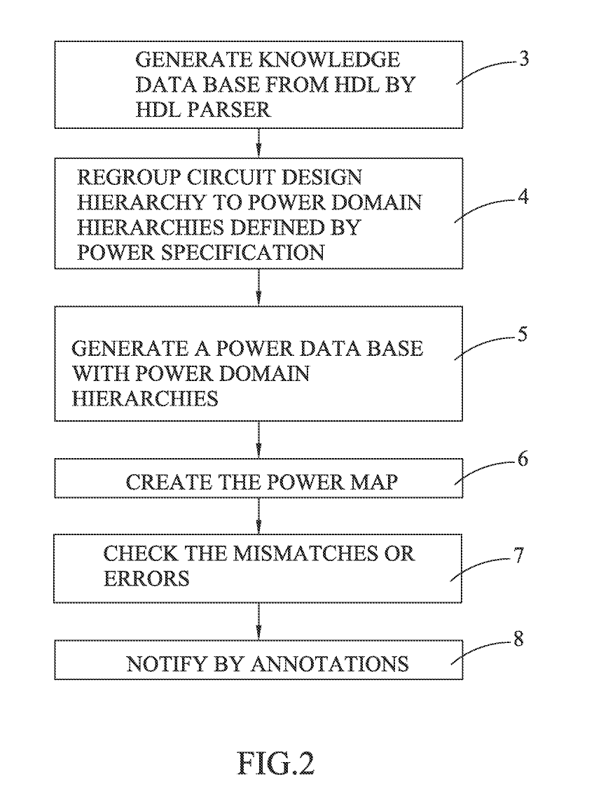

FIG. 2 is a flowchart for creating a power map of an Integrated Circuit (IC), in accordance with one embodiment of the present invention. At 3, the original text-based circuit design HDL codes are parsed and transformed into an internal structure and stored in a knowledge database. The knowledge database, which may be generated by an HDL parser, is an internal computer-readable data structure (which may have a hierarchical or a flattened structure) of the circuit design, and may be manipulated or controlled by software. At 4, power designs specified in CPF or UPF are parsed and transformed into internal structure by a CPF or UPF parser. Next, the original circuit design hierarchy in the knowledge database is regrouped into new design hierarchies defined by the power specification having a multitude of power domains. In the new hierarchies, the instances sharing the same power domain are grouped together. It is understood that the original design is not limited to hierarchical or flattened design. If the original circuit design is flattened and stored in the knowledge database, it may be partitioned into multiple power domains. At 5, the new design hierarchies are stored in a power database and transformed into an internal structure which is a computer-readable data structure of the circuit design and the power design. The power database may be manipulated, controlled or modified by software.

At 6, the power map is created based on the power data base and displayed via a user-friendly GUI (graphical user interface) window. The power map may include many objects such as power domain symbols and isolation cells, described in detail below. If a power domain in a power map is invoked in the user-friendly GUI window, for example, by the user click, the circuit design associated with the power domain is invoked. Therefore, the debugging of the entire chip with power network design and the related HDL code is more efficient and simpler than conventional techniques.

At 7 static checking may be performed to identify mismatches or errors between the power specification and the circuit design for improperly handled signals that connect the power domains. Such mismatches or errors may be shown to users by annotations, such as dotted lines, symbols, or colored highlights, as illustrated at 8.

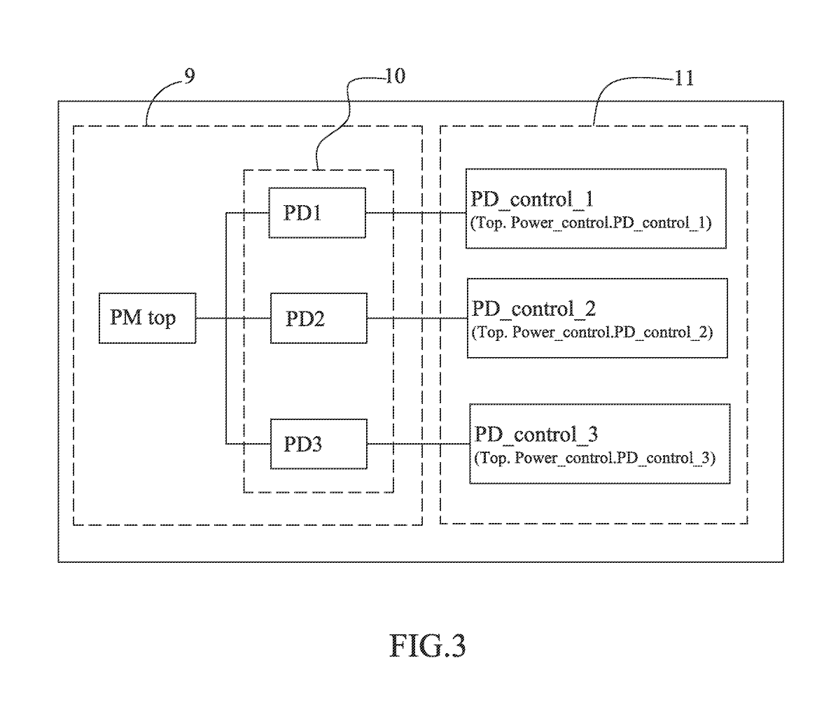

Referring to FIG. 3, frame 9 shows a power map in which the original circuit design hierarchy 11 of HDL is regrouped into new hierarchy 10 defined by a power specification and having a multitude of power domains. Each power domains includes a multitude of instances from the circuit design sharing the same power domain. The original design hierarchy 11 has a top level containing a multitude of instances including a module Power control with three instances PD_control_{—}1, PD_control_{—}2 and PD_control_{—}3. After regrouping in power map, a top level called PM_top is created. Instance PD_control_{—}1 is associated with and positioned under power domain PD1, instance PD_control_{—}2 is associated with and positioned under power domain PD2, and instance PD_control_{—}3 is associated with and positioned under power domain PD3.

After new hierarchies are defined by the power specification having a multitude of power domains, they can be stored in a power database, which is an internal computer-readable data structure integrating the circuit design and power network design information. The power database may be manipulated or controlled by software.

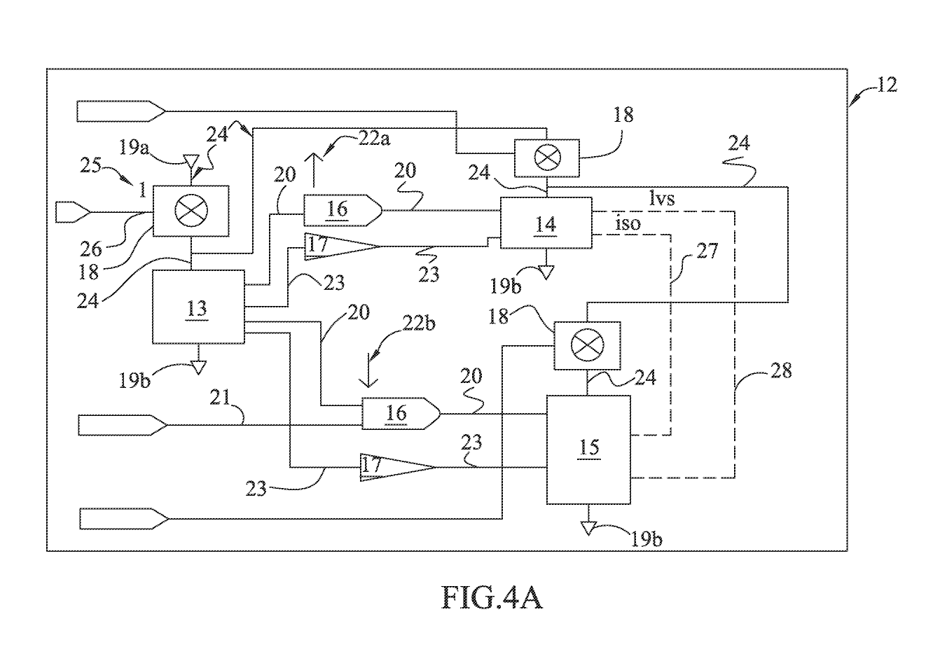

After the power data base is generated, the power map may be used to display the power network design, as shown in FIG. 4A. The power map 12 is shown as including a multitude of power domain symbols 13, 14 and 15 connected to grounds 19b, at least one isolation cell 16, at least one level shifter cell 17, at least one power switch cell 18, and at least one power supply 19a.

An isolation cell 16 representing an isolation command includes a multitude of isolation nets 20 for connection with power domains, and an isolation condition net 21 to present the isolation condition expression. Isolation cell 16 is shown as displaying a trigger status symbol positioned on the top-left of the isolation cell 16. If the associated condition's value is “1”, the trigger status is successful and the trigger status symbol displays an up-arrow 22a, otherwise the trigger status symbol displays a down-arrow 22b.

A level shifter cell 17 representing a level shifter command may include a multitude of level shifter nets 23 to connect with power domains.

A power switch cell 18 representing a power switch may include a multitude of power switch nets 24 for connection with a power supply 19a, or with one or more power domains, or with other power switch cells. Moreover, power switch cell 18 also includes a condition pin 26. When a user turns on active annotation, condition value 25 is annotated on condition pin 26. The active annotation provides for interaction and easy communication with the power map. The active annotation can be turned on by an “active annotation mechanism”. For example, it may be turned on by clicking a highlighted icon or a symbol, or by selecting an item using a mouse button to annotate the condition value 25 on the condition pin 26.

Furthermore, in one embodiment, the power map uses a dotted line of red color with mark “iso” 27 to display a signal without proper isolation, and a dotted line of red color with mark “lvs” 28 to display a signal without a level shifter.

The rules for each power component used in a power map are as follows.

### Isolation Rule (CPF/UPF)

Referring to FIG. 4B, the power map uses isolation cell 16 to represent isolation command in a power specification. Isolation cell 16 includes an isolation condition net 21 to present the isolation condition expression. Isolation cell 16 displays an isolation trigger status symbol on the top-left of the isolation cell. If the associated condition's value is “1”, the trigger status is successful and the trigger status symbol displays an up-arrow; otherwise the trigger status displays a down-arrow 22b.

### Level Shifter Rule (CPF/UPF)

Referring to FIG. 4C, the power map uses level shifter cell 17 to represent a level shifter command.

### Power Switch (CPF/UPF)

Referring to FIG. 4D, the power map uses power switch cell 18 to represent the power switch, thereby showing power switch condition value 25 on condition pin 26 when a user turns on the active annotation (such as by clicking the power switch cell 18).

### Non-Covered Connection

A signal connection connecting power domains but not specified by isolation rules and/or level shifter rules in the power specification is called non-covered connection. Referring to FIG. 4A, power map 12 provides a methodology to detect which HDL signals are not covered properly by isolation rules or level shifter rules, thereby to invoke this function automatically when power map 12 is created. In one embodiment, power map 12 uses a dotted line of red color with mark “iso” 27 to display a signal without proper isolation, and a dotted line of red color with mark “lvs” 28 to display a signal without a level shifter.

After the power map is generated, static checking can be performed to detect all mismatches or errors between the power specification and the circuit design to notify the user where such mismatches or errors occur. Mismatches or errors can occur in many ways. For example, the connectivity may be wrong in the isolation/level-shifter cell connection; the control signal may be missing or mismatched in power control signal connected to a power switch; the isolation cells may be useless due to mismatches or missing control signals or there may be improperly covered isolation connections or improperly covered level shifter connections due to missing isolation and/or level shifter cells for the nets connecting to the power domains. Furthermore, in order to ensure that there are both isolation and level shifter connections between two power domains which have HDL signals between them, the power map can create virtual nets (referred to alternatively herein as virtual power rule nets) therebetween to alert designers. For example, if two power domains do not have isolation and/or level shifter connections between them the power map will create a virtual level shifter power rule net and/or a virtual isolation power rule net between them. The impacted signals of each of the two virtual power rule nets are all the HDL signals between the two power domains.

Referring to FIG. 4A, each power domain symbol can be invoked to link to the part of the circuit design associated with the power domain. In one embodiment, when a user invokes the power domain symbol 13 by clicking it, the part of the circuit design associated with the power domain can be invoked to allow the user view the circuit design in order to debug the entire chip including power network design and the original HDL code.

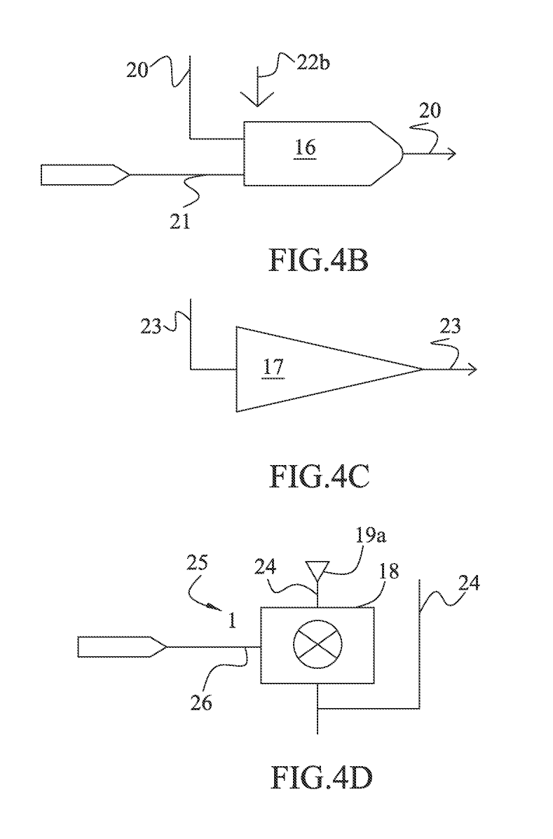

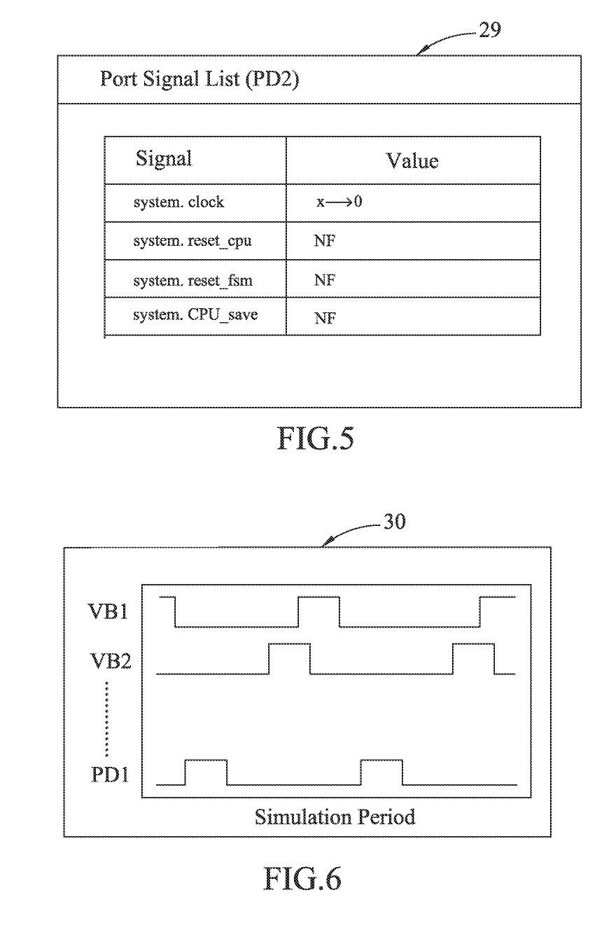

The power map is further adapted to display the current values of the simulated signals at any simulation time. In one embodiment, the power map includes a signal value list window 29, as shown in FIG. 5, to make debugging easier. When a user turns on the active annotation, such as by clicking a highlighted icon or a symbol or by selecting an item using a mouse, the signal value list window 29 will display the values of the corresponding simulated signals in the power map for that specific simulation time. Moreover, in one embodiment, the power map using a waveform window 30, as shown in FIG. 6, displays simulation waveforms (for any period of simulation) when a user drags and drops the selected signals in the power map. For example, when a user drags an isolation cell and drops it into the waveform window 30, the nets connecting the isolation level—and considered as variables (VBs)—are added automatically to the waveform window 30, thus resulting in the display of their waveforms automatically for a period of simulation time, as shown in FIG. 6. Similarly, the waveforms of the power component (e.g., power domain, PD) signals may also be displayed in the waveform window 30. In yet another embodiment, when a user moves the cursor in the waveform window 30 to a certain simulation time, nets in the power map are annotated with values of their associated signals at that specific time. Therefore, in accordance with the embodiments of the present invention, the process of debugging a power network and the digital circuit design is made easier and more efficient than conventional techniques.

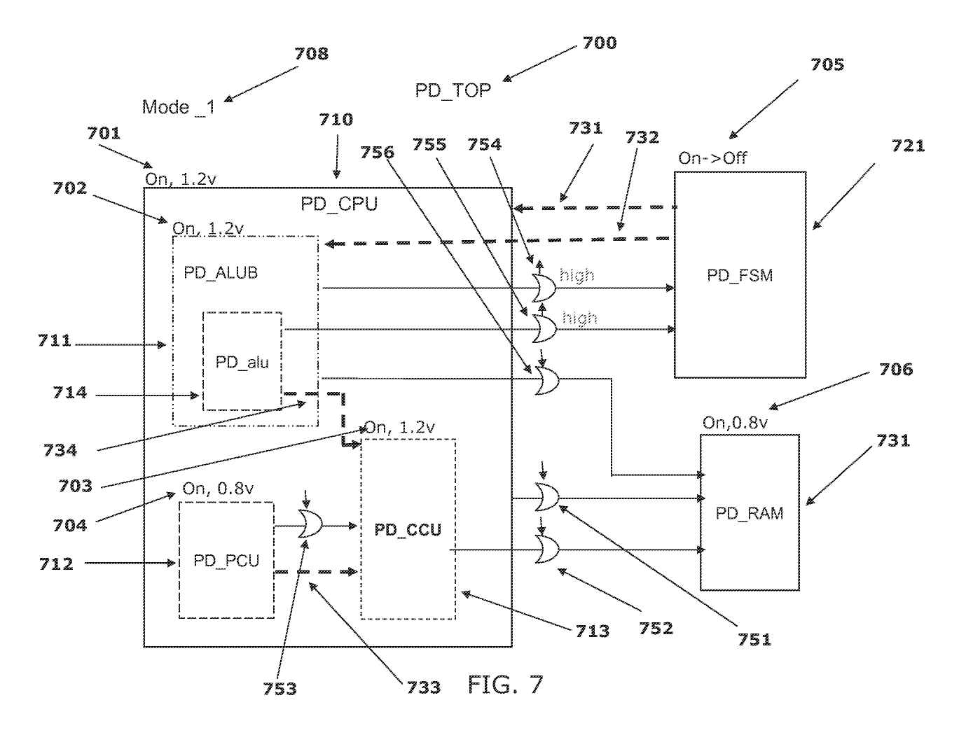

FIG. 7 shows a hierarchical a power map in which the power domains of the circuit design are grouped in accordance with a specification that includes a representation of the power domain boundaries as well as parent-child relationships within the power domains. Each power map is associated with a power control for controlling that power domain. As seen from FIG. 7, the top level of the power map named as PD_TOP 700 is shown as including three sets of parent power domains, namely PD_CPU 710, PD_FSM 721 and PD_RAM 731. Power domain PD_CPU 710 is shown as including three child power domains, namely PD_ALUB 711, PD_PCU 712 and PD_CCU 713, inside a rectangle representing the parent power domain PD_CPU 700. Within the PD_ALUB 711, there is shown one power domain PD_alu 714, thus indicating that there is a parent-child relationship between the parent power domain PD_ALUB 711 and the child power domain PD_alu 714. While FIG. 7 shows three levels of the hierarchy of the power map, it is understood that power map hierarchy may contain many more levels. The top level hierarchy is also shown as including a second power domain set PD_FSM 721; and a third power domain set PD_RAM 731. No child power domain is shown within the power domain PD_FSM 721 or PD_RAM 731. In order to present a hierarchical power map, at least one set of power domains contains at least two power domains, namely a parent power domain and at least one child power domain inside the parent power domain. Each of the power domains is associated with a corresponding power control for controlling that power domain. The status of the power control is displayed on the power map. The power control of a parent power domain can be used to control its child power domains as well. For example, in one embodiment, once the power of a parent power domain is turned off, all of the child domains inside the parent power domain will be turned off as well. However, if the power of the parent power domain is turned on, each of the child power domains can be turned on automatically or be subject to an additional local power control associated with the child power domain if necessary.

A status of the first power control 701 of the first set of the power domains PD_CPU 710 is displayed along the first rectangular shape. For example, the status of the first power control PD_CPU 701 shows that the first set of power domains is ON with a voltage level of 1.2V. Likewise, the status of power controls of power domains PD_ALUB 711, PD_PCU 712, PD_CCU 713, PD_FSM 721 and PD_RAM 731 are displayed as 702, 704, 703, 705 and 706 respectively. In another example, the status of the power control 705 of power domain PD_FSM 721 shows that the power of PD_FSM 721 is changed from ON to OFF. The status of the power control 706 of power domain PD_RAM 731 shows that the power of PD_RAM 731 is ON with a voltage level of 0.8V. In order to help debug a circuit, static checking may also be performed to identify mismatches or errors between the power specification and the circuit design for improperly handled signals that connect the power domains. Such mismatches or errors may be shown to users by one or more annotations, such as dotted lines, symbols, or colored highlights as illustrated in FIG. 7. The connections between power domains or hierarchical blocks of power domains having no isolation or level shifter cells may be highlighted with dotted lines, such as connection 731 between the power domain PD_CPU 710 and PD_FSM 721, connection 732 between the power domain PD_ALUB 711 and PD_FSM 721, connection 734 between the power domain PD_alu 714 and PD_CCU 713 and a connection 733 between the power domain PD_PCU 712 and PD_CCU 713.

The isolation cell 754 is shown as connecting the power domain PD_ALUB 711 to PD_FSM 721, and having a clamp value of logic “high”. Likewise, the isolation cell 755 is shown as connecting the power domain PD_alu 714 to PD_FSM 721 and having a clamp value of logic “high”. The isolation cell 756 is shown as connecting the power domain PD_ALUB 711 to PD_RAM 731. However, the clamp value of the isolation cell 754 is not defined and not shown in the power map. Likewise, the clamp values of the isolation cells 753, 754 and 752 are not defined and not shown in FIG. 7. Therefore, the conditions or errors among power domains may be viewed in a hierarchical power map to help with debugging the IC design.

For circuits having multiple operating modes, to avoid merging all the operating modes into a single power map which may make viewing complex and debugging difficult, each operating mode can have its own power map. As a result, for each mode, a corresponding hierarchical power map can be generated and displayed independently. For example, as shown in FIG. 7, the current operating mode is displayed on the top level of the power map as mode_{—}1 708.

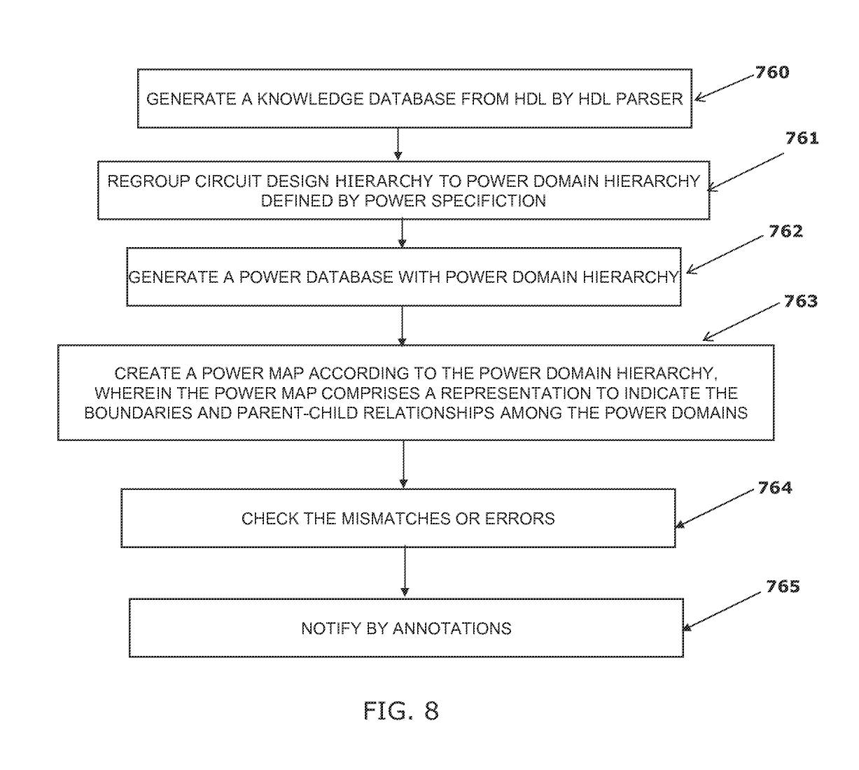

In one embodiment, the computer-implemented method for creating the power map, in accordance with the present invention, is as follows. As shown in FIG. 8, at 760, the original text-based circuit design HDL codes are parsed and transformed into internal structure and stored in a knowledge database. The knowledge database, which may be generated by a HDL parser, is an internal computer-readable data structure of the circuit design and may be easily manipulated or controlled by software. The knowledge database is generally hierarchical but may have a flattened structure. At 761, power designs specified in CPF or UPF are parsed and transformed into internal structure by a CPF or UPF parser. Thereafter, the original circuit design hierarchy in the knowledge database is regrouped into power domain hierarchies defined by the power specification having a multitude of power domains. At 762, the power domain hierarchies are stored in a power database and transformed into an internal structure which is a computer-readable data structure of the circuit design and the power design and which may be controlled by software. At 763 the power map is created according to the power domain hierarchy of the power database and displayed in a GUI window. The power map includes a multitude of power domains each of which is associated with a part of the circuit. The power map includes a first representation that indicates the boundaries and parent-child relationships among the power domains with at least one of the power domains containing at least one child power domain. Each power domains has a power control for controlling the power domain with the status of the power control displayed on the power map. The power control of a parent power domain can be used to control its child power domains as well. For example, in one embodiment, once the power of a parent power domain is turned off, all of the child domains inside the parent power domain may be turned off as well. However, if the power of the parent power domain is turned on, each of the child power domains can be turned on automatically or be made subject to an additional local power control associated with the child power domain if necessary.

At 764, static checking may be performed to detect mismatches or errors between the power specification and the circuit design for improperly handled signals that connect the power domains. The mismatches or errors may be displayed to users by one or more annotations such as dotted lines, symbols, or colored highlights as illustrated at 765.

The above embodiments of the present invention are illustrative and not limitative. Other additions, subtractions or modifications are obvious in view of the present disclosure and are intended to fall within the scope of the appended claims.

What is claimed is:

1. A computer-implemented method for debugging the power aspect of a circuit design specified in a power specification format by displaying a power map that integrates the power specification and the circuit design, the method comprising:
generating a knowledge database from the circuit design;
generating a power database according to the power specification and the knowledge database; and
generating and displaying the power map according to the power database using the computer, wherein the power map comprises a plurality of power domains each being associated with a different part of the circuit design, wherein the power map comprises a first representation that indicates boundaries and parent-child relationships among the plurality of power domains, wherein at least one of the plurality of power domains includes at least one child power domain, wherein at least one of the plurality of power domains is associated with a power control for controlling the power domain, and wherein a status of the power control is displayed on the power map.

2. The computer-implemented method in accordance with claim 1 wherein at least a subset of the plurality of power domains has an associated parent power domain and an associated child power domain.

3. The computer-implemented method in accordance with claim 2 further comprising the step of:
checking and displaying mismatches or errors between the power specification and the circuit design for signals connecting the plurality of power domains, wherein the checking and displaying further comprises:
displaying a virtual isolation connection net between at least two power domains if there are HDL signals between the at least two power domains and there are not any isolation connections between the at least two power domains; and
displaying a virtual level shifter connection net between the at least two power domains if there are HDL signals between the at least two power domains and there are not any level shifter connections between the at least two power domains.

4. The computer-implemented method in accordance with claim 2, wherein the power map is used with a simulation result, the computer-implemented method further comprising:
displaying current simulation values of signals in the power map; and
displaying a status of each power control using an ON or OFF symbol to indicate if the associated power domain is currently powered up or powered down, the status of a power control including a voltage level if the associated power domain is powered up.

5. The computer-implemented method in accordance with claim 1 wherein the power map further comprises at least one isolation cell representing an isolation command, the at least one isolation cell comprising a plurality of isolation nets for connection to the power domains.

6. The computer-implemented method in accordance with claim 1 wherein the power map further comprises at least one level shifter cell representing a level shifter command, the at least one level shifter cell comprising a plurality of level shifter nets for connection to the power domains.

7. The computer-implemented method in accordance with claim 1 wherein the power map further comprises at least one power switch cell representing a power switch, the at least one power switch cell comprising a plurality of power switch nets for connection to a power supply, or the power domains or at least one power switch cell.

8. The computer-implemented method in accordance with claim 5 wherein the virtual isolation connection net or the virtual level shifter connection net are represented in either dotted or colored lines.

9. A computer system adapted to debug the power aspect of a circuit design specified in a power specification format by displaying a power map that integrates the power specification and its corresponding circuit design, the computer system comprising a processor and a computer-readable storage medium adapted to store instruction, wherein said instructions when executed by the processor cause the processor to:
generate a knowledge database from the circuit design;
generate a power database according to the power specification and the knowledge database; and
generate and display the power map according to the power database, wherein the power map comprises a plurality of power domains each associated with a different part of the circuit design, wherein the power map comprises a first representation that indicates boundaries and parent-child relationships among at least a subset of the plurality of power domains, wherein at least one of the plurality of power domains includes at least one child power domain, wherein at least one of the plurality of power domains is associated with a power control for controlling the at least one power domain, wherein the status of the power control is displayed on the power map.

10. The computer system of claim 9 wherein at least a subset of the plurality of power domains has an associated parent power domain and an associated child power domain.

11. The computer system of claim 10 wherein said instructions when executed by the processor further cause the processor to:
check and display mismatches or errors between the power specification and the circuit design for signals connecting the plurality of power domains, wherein the check and display further comprises:
display a virtual isolation connection net between at least two power domains if there are HDL signals between the at least two power domains and there are not any isolation connections between the at least two power domains; and
display a virtual level shifter connection net between the at least two power domains if there are HDL signals between the at least two power domains and there are not any level shifter connections between the at least two power domains.

12. The computer system of claim 10 wherein the power map is used with a simulation result, wherein said instructions when executed by the processor further cause the processor to:
display current simulation values of signals in the power map; and
display a status of each power control using an ON or OFF symbol to indicate if the associated power domain is currently powered up or powered down, the status of a power control including a voltage level if the associated power domain is powered up.

13. The computer system of claim 9 wherein the power map further comprises at least one isolation cell representing an isolation command, the at least one isolation cell comprising a plurality of isolation nets for connection to the power domains.

14. The computer system of claim 9 wherein the power map further comprises at least one level shifter cell representing a level shifter command, the at least one level shifter cell comprising a plurality of level shifter nets for connection to the power domains.

15. The computer system of claim 9 wherein the power map further comprises at least one power switch cell representing a power switch, the at least one power switch cell comprising a plurality of power switch nets for connection to a power supply, the power domains or at least one power switch cell.

16. The computer system of claim 13 wherein the virtual isolation connection net or the virtual level shifter connection net are represented in either dotted or colored lines.

17. A computer-readable storage medium comprising instructions that when executed by a processor cause the processor to debug the power aspect of a circuit design specified in a power specification format by displaying a power map that integrates the power specification and its corresponding circuit design, the computer-readable storage medium further comprising instructions that when executed by the processor further cause the processor to:
generate a knowledge database from the circuit design;
generate a power database according to the power specification and the knowledge database; and
generate and displaying the power map according to the power database, wherein the power map comprises a plurality of power domains each associated with a different part of the circuit design, wherein the power map comprises a first representation that indicates boundaries and parent-child relationships among at least a subset of the plurality of power domains, wherein at least one of the plurality of power domains includes at least one child power domain, wherein at least one of the plurality of power domains is associated with a power control for controlling the at least one power domain, wherein the status of the power control is displayed on the power map.

18. The computer-readable storage medium 17 wherein at least a subset of the plurality of power domains has an associated parent power domain and an associated child power domain.

19. The computer-readable storage medium of claim 18 wherein said instructions when executed by the processor further cause the processor to:
check and display mismatches or errors between the power specification and the circuit design for signals connecting the plurality of power domains, wherein the check and display further comprises:
display a virtual isolation connection net between at least two power domains if there are HDL signals between the at least two power domains and there are not any isolation connections between the at least two power domains; and
display a virtual level shifter connection net between the at least two power domains if there are HDL signals between the at least two power domains and there are not any level shifter connections between the at least two power domains.

20. The computer-readable storage medium of claim 18 wherein the power map is used with a simulation result, wherein said instructions when executed by the processor further cause the processor to:
display current simulation values of signals in the power map; and
display a status of each power control using an ON or OFF symbol to indicate if the associated power domain is currently powered up or powered down, the status of a power control including a voltage level if the associated power domain is powered up.

21. The computer-readable storage medium of claim 17 wherein the power map further comprises at least one isolation cell representing an isolation command, the at least one isolation cell comprising a plurality of isolation nets for connection to the power domains.

22. The computer-readable storage medium of claim 17 wherein the power map further comprises at least one level shifter cell representing a level shifter command, the at least one level shifter cell comprising a plurality of level shifter nets for connection to the power domains.

23. The computer-readable storage medium of claim 17 wherein the power map further comprises at least one power switch cell representing a power switch, the at least one power switch cell comprising a plurality of power switch nets for connection to a power supply, the power domains or at least one power switch cell.

24. The computer-readable storage medium of claim 21 wherein the virtual isolation connection net or the named virtual level shifter connection net are represented in either dotted or colored lines.
